(19) United States
(12) Patent Application Publication
(10) Pub. No.: US 2007/0099810 A1
(43) Pub. Date: May 3, 2007

(54) Cleaning liquid and cleaning method

(76) Inventors: Hiroshi Matsunaga, Tokyo (JP); Masaru Ohto, Tokyo (JP); Hiroshi Yoshida, Chiba (JP); Eiko Kuwabara, Chiba (JP); Ming Fang, Portland, OR (US); Lourdes Dominguez, Beaverton, OR (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/259,256

(22) Filed: Oct. 27, 2005

(51) Int. Cl. C11D 3/395; C11D 17/00

(52) U.S. Cl. 510/302; 510/421; 510/407

(57) ABSTRACT

A cleaning liquid which comprises at least one selected from potassium hydroxide or sodium hydroxide in an amount of 0.01 to 10% by weight, water-soluble organic solvent in an amount of 5 to 80% by weight, a corrosion inhibitor at least one selected from the group consisting of group IX metal of the Periodic Table, group IX metal alloy and group XI metal of the Periodic Table in an amount of 0.0001% by weight and water. The present provides a cleaning liquid and a cleaning method both capable of removing photoresists or its deposits and attached articles on the surface of treated substances such as organosiloxane-based anti-reflection film, configuration protective coat or so without corroding the treated substances, particularly low dielectric constant film, group IX metals of the Periodic Table and their alloy, and group XI metals of the Periodic Table.

### TECHNICAL FIELD

The present invention relates to a cleaning liquid and a cleaning method both for removing deposits on the surface of substrates of semiconductor integrated circuit, liquid crystal panel, organic electroluminescent panel, printed circuit board, micro-electromechanical system, etc., in their manufacturing process.

### BACKGROUND ART

Nowadays, a lithography method is generally employed for producing semiconductor devices such as highly integrated LSI, etc., or display devices such as liquid crystal panel and organic EL device. In the case where, for example, the semiconductor devices are produced by the lithography method, after forming electrically conductive thin film such as metallic film operating as electrically conductive wiring materials or interlayer insulating films such as silicon oxide film for the purpose of insulating between the electrically conductive thin film and the wiring on the surface of substrates of silicon wafers, etc., providing a photosensitive layer by applying photoresist over the surface, followed by carrying out selective exposure & development on the photosensitive layer, and resultantly forming desired resist pattern. Subsequently, applying dry etching treatment on the thin film at lower layers as a mask of this resist pattern, form a desired pattern over the thin film. A serial process of further removing the resist pattern and residues of the dry etching treatment completely is generally conducted.

In late years, microfinarization of design rule advanced and as a result, signal transmission delay became to control a speedup limit. Accordingly, replacing aluminum as wiring material for electrical conduction with copper of low electric resistance and an introduction of a low dielectric constant (Low-k) film as the interlayer insulation film advance day by day. Because copper diffuses into the interlayer insulating film at a process temperature, both the side face and the bottom face are usually covered with metallic diffusion prevention film such as Ta or TaN, and the top face of the copper wiring is covered by insulative diffusion prevention film such as SiN, SiC or so. However, because the insulative diffusion prevention film has large dielectric constant, even an employment of low dielectric constant (Low-k) film as the interlayer insulating film cannot achieve over all reduction of the dielectric constant as a whole device. Accordingly, there is a case where Co or Co alloy which are metallic diffusion prevention film is employed for covering top face of the copper wiring in order to evade failing in the over all reduction of the dielectric constant as a whole device. Further, there is a case where organosiloxane-based compound is employed as an anti-reflection film for raising an exposure precision between the photoresist and the interlayer insulation film or as a configuration protective coat to protect pattern configuration from dry etching. The organosiloxane-based compound is removed together with the photoresist.

Conventionally, a cleaning liquid comprising a mixed solution of alkanolamine and organic solvent (refer to Japanese Unexamined Patent Application Laid-Open Nos. Shou 62-49355 and Shou 64-42653) or a cleaning liquid comprising alkanolamine, hydroxyl amine, catechol and water (refer to Japanese Unexamined Patent Application Laid-Open No. Hei 4-289866) is known as a cleaning liquid removing the photoresist and the residues. However, while these cleaning liquids are appropriate for elements containing aluminum or aluminum alloy, it is extremely difficult to apply these cleaning liquids in the case of the elements containing cobalt which is group IX metal and copper which is group XI metal both of the Periodic Table because both metals will corrode. Further, although a remover solution employing organic quaternary ammonium (refer to, U.S. Pat. No. 5,185,235) causes very little corrosion of cobalt which is group IX metal and copper which is group XI metal both of the Periodic Table, feasibility test by the inventor et al. exhibited not only insufficient resist detachability but also insufficient removing ability for organosiloxane-based compounds. Furthermore, Japanese Unexamined Patent Application Laid-Open No. 2003-213463 proposes a corrosion inhibitor for metals which comprises at least one kind of a compound selected from a group consisting of triazine derivative, pterin derivative and fluoroalkyl acrylate copolymer and a cleaning liquid containing the corrosion inhibitor for metals, however, they also exhibited insufficient corrosion inhibiting effect against group IX metal of the Periodic Table.

### DISCLOSURE OF THE INVENTION

An object of the present invention is to provide a cleaning liquid and a cleaning method both capable of removing photoresists or its deposits and attached articles on the surface of treated substances such as organosiloxane-based anti-reflection film, configuration protective coat or so without corroding the treated substances, particularly low dielectric constant film, group IX metals of the Periodic Table and their alloy, and group XI metals of the Periodic Table.

The present invention was completed by zealously examining in order to achieve the object and by finding that the specific corrosion inhibitors among the corrosion inhibitors generally used for group XI metals of the Periodic Table beginning from copper exhibit a corrosion inhibiting effect against group IX metals of the Periodic Table such as cobalt or so. Namely, it was found that using a cleaning liquid which comprises at least one selected from potassium hydroxide or sodium hydroxide in an amount of 0.01 to 10% by weight, water-soluble organic solvent in an amount of 5 to 80% by weight, a corrosion inhibitor against at least one selected from the group consisting of IX group metal of the Periodic Table, group IX metal alloy and group XI metal of the Periodic Table in an amount of 0.0001% by weight and water or a cleaning liquid which comprises at least one selected from potassium hydroxide or sodium hydroxide in an amount of 0.01 to 10% by weight, water-soluble organic solvent in an amount of 5 to 80% by weight, at least one kind of corrosion inhibitor selected from the group selected from aromatic heterocyclic compound, nonionic surfactant and thioureas in an amount of 0.0001 to 10% by weight and water enables to remove photoresists or its deposits and attached articles on the surface of treated substances such as organosiloxane-based anti-reflection film, configuration protective coat or so without corroding the treated substances, particularly low dielectric constant film, group IX metals of the Periodic Table and their alloy, and group XI metals of the Periodic Table. The present invention has been completed based on such knowledge.

The present invention enables to remove photoresists or its deposits and attached articles on the surface of treated substances such as organosiloxane-based anti-reflection film, configuration protective coat or so all after dry etching without corroding the treated substances.

### BRIEF DESCRIPTION OF THE DRAWINGS

FIG. 1 illustrates a cross sectional image of a silicon substrate used in Example and Comparative Example.

### DESCRIPTION OF THE PREFERRED EMBODIMENTS

At least one selected from potassium hydroxide or sodium hydroxide employed in the present invention is used in an amount of 0.01 to 10% by weight, preferably in an amount of 0.1 to 5% by weight both expressed as a concentration. The concentration of 0.01% by weight or greater of potassium hydroxide or sodium hydroxide enables to remove resist or its residue and when it exceeds 10% by weight, there will be an anxiety of causing corrosion in the substrate materials.

Typical examples of water-soluble organic solvent in the present invention include alcohol-based solvent such as methyl alcohol, ethyl alcohol, 1-propyl alcohol, 2-propyl alcohol, ethyleneglycol, propyleneglycol, glycerol, 1,6-hexanediol, neopentylglycol, trimethylolpropane, 1,2,4-butanediol, 1,2,6-hexanetriol, sorbitol, xylitol, etc.; ether-based solvent such as ethyleneglycol monomethylether, ethyleneglycol monoethylether, ethyleneglycol monobutylether, diethyleneglycol, diethyleneglycol monomethylether, diethyleneglycol monoethylether, diethyleneglycol monobutylether, triethyleneglycol, tetraethyleneglycol, polyethylene glycol, propyleneglycol monomethylether, propyleneglycol monoethylether, propyleneglycol monobutylether, dipropyleneglycol monomethylether, dipropyleneglycol monoethylether, dipropyleneglycol monobutylether, diethyleneglycol dimethylether, dipropyleneglycol dimethylether, 3-methyl-3-methoxy butanol, etc.; amide-based solvent such as formamide, monomethylformamide, dimethylformamide, monoethylformamide, diethylformamide, acetamide, monomethylacetamide, dimethylacetamide, monoethylacetamide, diethylacetamide, N-methylpyrrolidone, N-ethylpyrrolidone, etc.; sulfur containing solvent such as dimethylsulfone, dimethylsulfoxide, sulfolane, etc.; imidazolidinone-based solvent such as 1,3-dimethyl-2-imidazolidinone, 1,3-diethyl-2-imidazolidinone, 1,3-diisopropyl-2-imidazolidinone, etc.; and lactone-based solvent such as γ-butyrolactone, δ-valerolactone, etc. Among these, alcohol-based solvent, ether-based solvent and amide-based solvent are preferable, and 1,6-hexanediol, tetraethyleneglycol, propyleneglycol, dipropyleneglycol monomethylether and N-methylpyrrolidone are further preferable. The water-soluble organic solvent may be used alone or in combination of two or more kinds thereof. Further, it is usually used in an amount of 5 to 80% by weight, preferably in an amount of 20 to 50% by weight each expressed as the concentration. When the amount of the water-soluble organic solvent is less than 5% by weight or when it exceeds 80% by weight, degradations in its cleaning effect and corrosion inhibiting effect are apprehended.

The corrosion inhibitor used in the present invention is at least one kind selected from the group consisting of aromatic heterocyclic compounds, nonionic surfactants and thioureas. The aromatic heterocyclic compounds have totally 2 to 4 hetero atoms of only nitrogen atoms or of nitrogen atoms and sulfur atoms. Examples of the aromatic heterocyclic compounds having 2 nitrogen atoms only include imidazole, 1-methylimidazole, 2-methylimidazole, 4-methylimidazole and 3-methyl-5-pyrazolone. Examples of the aromatic heterocyclic compounds having 3 nitrogen atoms only include 1,2,4-triazole, 3-amino-1, 2,4-triazole, 4-amino-1, 2,4-triazole, 3,5-diamino-1, 2,4-triazole, methyl 1,2,4-triazole-3-carboxylate, 1-hydroxybenzotriazole, 1,2,3-benzotriazol, 5-methyl-1H-benzotriazol, 1H-4/5 methylbenzotriazole, 2-(3,5-t-butyl-2-hydroxyphenyl) benzotriazole and 1H-benzotriazol-1-methanol. Examples of the aromatic heterocyclic compounds having 4 nitrogen atoms only include 5-phenyltetrazole, 5-amino-1H-tetrazole, 1H-tetrazole-1-acetic acid and 5-(3-aminophenol) tetrazole. Examples of the aromatic heterocyclic compounds having single nitrogen atom and single sulfur atom include 2-mercaptobenzothiazole, and examples of the aromatic heterocyclic compounds having 2 nitrogen atoms and single sulfur atom include 2,5-dimercapto-1,3,4-thiadiazole.

The nonionic surfactant is at least one kind nonionic surfactant selected from a group consisting of ether type, ether ester type, ester type and nitrogen-containing type nonionic surfactants. Examples of the ether type nonionic surfactant include polyoxyalkylene alkylether and polyoxyethylene-polyoxypropylene block polymer. Examples of the ether ester type nonionic surfactant include alkylmonoglyceryl ether. Examples of the ester type nonionic surfactant include fatty acid sorbitan ester and alkylpolyglucoside. Examples of the nitrogen-containing type nonionic surfactant include polyoxyethylene alkylamine and fatty acid diethanolamide.

Typical examples of the thioureas employed as the corrosion inhibitor include thiourea, diphenylthiourea, dimethylolthiourea, thioureadioxide, N-t-butyl-N′-isopropylthiourea, 1,3-dibutyl-2-thiourea, 1 -allyl-3-(2-hydroxyethyl)-thiourea, 1-benzoyl-2-thiourea, 2,5-dithiobiurea, 2-imino-4-thiobiuret, etc. Preferable aromatic heterocyclic compounds used as the corrosion inhibitor are 3-amino-1,2,4-triazole, 3,5-diamino-1, 2,4-triazole, 1,2,3-benzotriazol, 5-methyl-1H-benzotriazol and 5-amino-1H-tetrazole. Preferable nonionic surfactant used as the corrosion inhibitor is polyoxyethylene-polyoxypropylene block polymer. Further, preferable thioureas used as the corrosion inhibitor are 1-benzoyl-2-thiourea, 2,5-dithiobiurea and 1,3-dibutyl-2-thiourea. These corrosion inhibitors may be singly or in combination of two or more, in an amount of 0.0001 to 10% by weight, preferably in an amount of 0.005 to 3% by weight each as the concentration. When the amount of the corrosion inhibitor is less than 0.0001% by weight, the effect of corrosion inhibition cannot be expected. When it exceeds 10% by weight, degradation of the cleaning effect is apprehended.

Further, conventional additives employed to the cleaning liquid may be blended as far as they do not interrupt the object of the invention.

The temperature for carrying out the cleaning method of the present invention is usually within the range of from room temperature to 120° C., and it may be appropriately selected taking an etching condition or the substance to be treated into consideration.

Typical examples of the substance to be treated with the cleaning method of the present invention include semiconductor wiring materials such as silicon, amorphous-silicon, poly silicon, silicon oxide, silicon nitride, copper, titanium, titanium-tungsten, titanium nitride, tungsten, tantalum, tantalum compound, chromium, chromium oxide, chromium alloy, etc.; semiconductor substrates whereon compound semiconductors such as gallium-arsenic, gallium-phosphor, indium-phosphor or so is carried; print circuit boards such as polyimide resin, etc.; or glass substrates thaht are employed for LCDs, etc. The cleaning liquid of the present invention do not corrode the above substances.

The cleaning method of the present invention may be accompanied by an application of ultrasonic wave if necessary. With regard to rinsing after removing the photoresist over the substances treated or their residues, any use of organic solvent such as alcohol is not necessary and only a water rinsing is enough. A pretreatment liquid containing hydrogen peroxide will be effective for stripping the denaturated photoresist.

### EXAMPLE

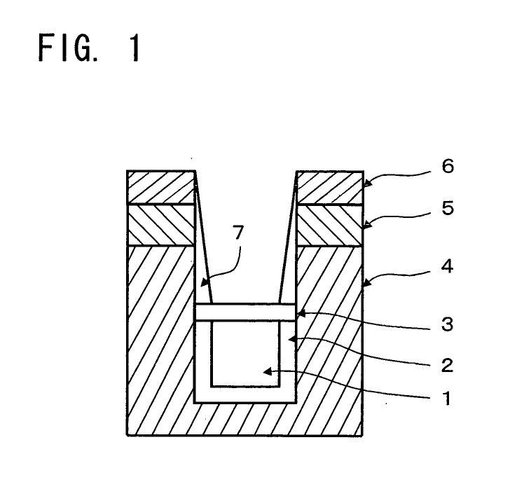

The present invention shall be explained below in further details with reference to examples, but the present invention shall by no means be restricted by the following examples. FIG. 1 is a partially sectional view of the substrate having a via structure layered with copper 1 as a wiring material, TaN film 2 over the surface and bottom surface and Co film 3 over the top surface each as diffusion prevention films, SiOC base film 4 as an interlayer insulating film, organosiloxane-based compound 5 as reflection inhibiting film and photoresist 6. The substrate was used in Examples and Comparative Examples. There is residue 7 on the inner wall of the interlayer insulation film.

### Examples 1 to 6 and Comparative Examples 1 to 4

After washing the substrate shown on FIG. 1 with the cleaning liquid described in Tables 1 and 2 each under the predetermined condition respectively, they were rinsed with ultra pure water and dried. Subsequently, observing their section with the scanning electron microscope, the removing property of photoresist, organosiloxane-based anti-reflection film and residues, and the corroded level of cobalt, copper and SiOC base interlayer insulating film were evaluated under the following decision standard. The results were shown in Table 1 (Examples 1 to 6) and Table 2 (Comparative Examples 1 to 4).

Further, criteria for evaluation are as follows:

=Removing Property of Photoresist =

A: Perfect removal
B: Although the photoresist and the anti-reflexion film were removed, the residues partly remained.
C: The photoresist and/or the anti-reflection film partly remained and also, the residues remained.
D: The photoresist, the anti-reflection film and residues remained.
   =Corrosion=
A: Corrosion was not recognized at all.
B: A little corrosion was recognized on at least one substance among cobalt, copper and SiOC base interlayer insulating film.

C: A large corrosion was recognized on at least one substance among cobalt, copper and SiOC base interlayer insulating film.

TABLE 1

| | | Ex. 1 | Ex. 2 | Ex. 3 | Ex. 4 | Ex. 5 | Ex. 6 |
|---|---|---|---|---|---|---|---|
| Composition | Potassium hydroxide | 0.1 | 0.4 | 3 | 1.6 | 0.3 | 0.7 |
| | N-methylpyrrolidon | 70 | — | — | — | — | 30 |
| | Tetraethyleneglycol | — | — | 20 | — | 25 | — |
| | Dipropyleneglycolmonomethylether | — | 40 | — | — | 10 | 20 |
| | 1,6-hexanediol | — | — | — | 30 | — | — |
| | 1,2,4-triazole | — | — | 2 | — | — | — |
| | 5-amino-1H-tetrazole | — | 0.01 | — | 0.01 | — | 0.5 |
| | EPAN 710 | — | — | — | — | 0.05 | 0.1 |
| | 2,5-dithiobiurea | 0.3 | — | — | — | — | — |
| | Water | 29.6 | 59.59 | 75 | 68.39 | 64.65 | 48.7 |
| Condition | Temperature (° C.) | 70 | 70 | 50 | 30 | 60 | 60 |
| | Time (minutes) | 30 | 10 | 3 | 10 | 20 | 15 |
| Evaluation | Removing property of photoresist, | A | A | A | A | A | A |
| | anti-reflection film and residue | | | | | | |
| | Corrosion of | A | A | A | A | A | A |
| | cobalt and copper | | | | | | |
| | Corrosion of | A | A | A | A | A | A |
| | SiOC base interlayer insulation film | | | | | | |

EPAN 710: Polyoxyethylene-polyoxypropylene block polymer-based nonionic surfactant, available from DAI-ICHI KOGYO SEIYAKU CO., LTD.

TABLE 2

| | | Co. Ex. 1 | Co. Ex. 2 | Co. Ex. 3 | Co. Ex. 4 |
|---|---|---|---|---|---|
| Composition | Potassium hydroxide | — | 15 | 0.5 | — |
| | Tetramethylammonium hydroxide | — | — | — | 3 |
| | Triethyleneglycol | 50 | — | — | 30 |
| | Sulfolane | — | — | 40 | — |
| | EPAN U-108 | 0.03 | — | — | 0.10 |
| | 1-benzoyl-2-thiourea | — | 3 | — | — |
| | Water | 49.97 | 82.00 | 59.50 | 66.9 |
| Condition | Temperature (° C.) | 50 | 70 | 60 | 70 |
| | Time (minutes) | 40 | 10 | 20 | 40 |
| Evaluation | Removing property of photoresist, | D | B | A | C |
| | anti-reflection film and residue | | | | |
| | Corrosion of | A | A | B | A |
| | cobalt and copper | | | | |
| | Corrosion of | A | C | A | A |
| | SiOC base interlayer insulation film | | | | |

EPAN U-108: Polyoxyethylene-polyoxypropylene block polymer-based nonionic surfactant, available from DAI-ICHI KOGYO SEIYAKU CO., LTD.

As is indicated in Table 1, it was verified that cobalt as group IX metal and copper as group XI metal both in the Periodic Table and the SiOC base interlayer insulating film were not corroded, and the removing properties of photoresist, organosiloxane-based anti-reflection film and residues were superior in Examples 1 to 6 employing the cleaning liquid and the cleaning method in accordance with the present invention. In Comparative Examples, it was verified either that the removal of photoresist, anti-reflexion film and residues was not perfect or that at least one substance among cobalt, copper and SiOC base interlayer insulating films was corroded.

### INDUSTRIAL APPLICABILITY

The present invention enables to remove photoresists or its deposits and attached articles on the surface of treated substances such as organosiloxane-based anti-reflection film, configuration protective coat or so all after dry etching without corroding the treated substances.

Having described the invention in detail, those skilled in the art will appreciate that, given the present disclosure, modifications may be made to the invention without departing from the spirit of the inventive concept described therein. Therefore, it is not intended that the scope of the invention be limited to the specific and preferred embodiments illustrated and described. Rather, it is intended that the scope of the invention be determined by the appended claims.

What is claimed is:

1. A cleaning liquid which comprises at least one selected from potassium hydroxide or sodium hydroxide in an amount of 0.01 to 10% by weight, water-soluble organic solvent in an amount of 5 to 80% by weight, a corrosion inhibitor at least one selected from the group consisting of group IX metal of the Periodic Table, group IX metal alloy and group XI metal of the Periodic Table in an amount of 0.0001% by weight and water.

2. The cleaning liquid according to claim 1, wherein said water-soluble organic solvent is at least one kind selected from the group consisting of ether-based solvent, amide-based solvent and alcohol-based solvent.

3. The cleaning liquid according to claim 1, wherein said group IX metal of the Periodic Table is cobalt and said group XI metal of the Periodic Table is copper.

4. A cleaning liquid which comprises at least one selected from potassium hydroxide or sodium hydroxide in an amount of 0.01 to 10% by weight, water-soluble organic solvent in an amount of 5 to 80% by weight, at least one kind of corrosion inhibitor selected from aromatic heterocyclic compound, nonionic surfactant and thioureas in an amount of 0.0001 to 10% by weight and water.

5. The cleaning liquid according to claim 4, wherein said corrosion inhibitor is an aromatic heterocyclic compound having totally 2 to 4 hetero atoms of only nitrogen atoms or of nitrogen atoms and sulfur atoms.

6. The cleaning liquid according to claim 4, wherein said corrosion inhibitor is at least one kind of nonionic surfactant selected from a group consisting of ether type, ether ester type, ester type and nitrogen-containing type nonionic surfactant.

7. The cleaning liquid according to claim 5, wherein said aromatic heterocyclic compound is 3-amino-1,2,4-triazole, 3,5-diamino-1,2,4-triazole, 1,2,3-benzotriazole, 5-methyl-1H-benzotriazole or 5-amino-1H-tetrazole.

8. The cleaning liquid according to claim 6, wherein said nonionic surfactant is polyoxyethylene-polyoxypropylene block polymer.

9. The cleaning liquid according to claim 4, wherein said thiourea is 1-benzoyl-2-thiourea, 2,5-dithio bi urea or 1,3-dibutyl-2-thiourea.

10. A cleaning method which removes organosiloxane-based anti-reflection film or configuration protective coat with the use of the cleaning liquid according to any one described in claims 1 to 9.
